(19) United States
(12) Patent Application Publication
(10) Pub. No.: US 2016/0105207 A1
(43) Pub. Date: Apr. 14, 2016

(54) MOBILE DEVICE CASE WITH GPS TRACKING

(71) Applicants: JASON ROSEN, Toronto (CA); SHAWNDA ROSEN, Toronto (CA)

(72) Inventors: JASON ROSEN, Toronto (CA); SHAWNDA ROSEN, Toronto (CA)

(21) Appl. No.: 14/753,517

(22) Filed: Jun. 29, 2015

Related U.S. Application Data
(60) Provisional application No. 62/062,124, filed on Oct. 9, 2014.

(51) Int. Cl. H04B 1/3888; H02J 7/00; G01K 13/00; H02J 7/35; H04L 9/32; G01S 19/14

(52) U.S. Cl. CPC H04B 1/3888; H04L 9/3226; G01S 19/14; G01K 13/00; H02J 7/35; H02J 7/0052

(57) ABSTRACT

A mobile device case for a mobile device having a first battery to operate, said mobile device case comprising of a housing to receive said mobile device; a second battery being embedded in said housing; a pair of thermometers embedded in said housing to monitor the temperature of said first battery and ambient surrounding said housing; a GPS device to determine the location of the mobile device case; an electronic communication means to communicate with a plurality of satellites to send and receive a data related to the location of the mobile device case; and a processor to process the functionality of said second battery, said thermometers, said GPS device and said communication means and switch between said second battery and said first battery; whereby the processor switches the power source of the mobile device from said first battery to said second battery when said first battery is dead.

### RELATED APPLICATIONS

The present invention claims the priority date of the U.S. Provisional Patent No. 62/062,124 filed Oct. 09, 2014.

### FIELD OF THE INVENTION

The present invention relates to mobile accessories and specially relates to mobile device cases with GPS tracking.

### BACKGROUND OF THE INVENTION

In increasing market of cell phones, carriers of such devices are looking for opportunities to increase profits by providing new services. People all over the world lose their phones on a daily basis. When the unfortunate incident does occur, the owner of the phone will frequently try to call their phone, or locate it by means of a GPS internet application communicating with a GPS receiver which tends to be embedded in some newer cell phone models. If the phone is turned on, and still has battery life, then the GPS receiver can be used to track the position of the phone. If, however, the phone is powered off, or the battery has died, then the owner will be unable to track the device through the GPS receiver embedded in the phone, as this component of the phone is powered by the phone battery.

Techniques for the positioning of mobile devices in a wireless environment are important for a number of applications. GPS-based techniques are known to provide accurate position measurements. In this case, the GPS should be ON all time to be tracked by satellites on unfortunate incident.

A principal disadvantage of always keeping the device in an -on mode is the drain on the battery resources of the mobile device. Battery power in a mobile device is a precious resource, and any steps that can be taken to maximize battery life are advantageous. Simply keeping a GPS device powered on at all time is generally considered an unacceptable solution.

When people lose their phone and the phone is powered off, or the battery has died, in this situation a mobile case that is easily attached to mobile phones and extends the functionality by a combination with GPS may function as a standalone device. This is a solution to have an additional device for tracking the lost phone.

This invention discloses a cell-phone case, similar to cases already used in the market to protect cell phones, with the added feature of a GPS tracking device embedded in the case itself.

### SUMMARY OF THE INVENTION

The invention relates to a mobile device case (cell phone case), which contains an embedded GPS tracking system to locate the mobile device to which the case is attached in the event that either 1) there is currently no tracking device embedded into the mobile device or 2) the individual is unable to locate the mobile device due to the device's low/no battery life or the device being turned off.

While some mobile devices have GPS tracking data embedded into the mobile device itself, there is a need for cases for mobile devices that have embedded GPS tracking components within the case itself.

There is an object of the present invention that is applicable to mobile devices without GPS system.

In today's tracking system collecting and transferring data's lower the battery level very quickly. It is another object of the present invention having a thermometer for measuring the temperature of the phone battery. The GPS device embedded in the case could tend to sit idle, only using minimum battery power, until the battery is completely dead and the unit is deemed to be without power. At that point the unit could tend to power up into full mode ready to be accessed.

It is another object of the present invention to have a GPS tracking in mobile case to use whenever the battery of mobile device is power off.

The mobile device case with GPS tracking may be including indicator lights that informs the user when the battery level for the GPS device in the case is low.

The mobile device case with GPS tracking, further having a unique PIN associated with it. Whenever the user first purchases the product, they could tend to register their PIN, on a website for example, where they could also setup a password and initialize their profile. In the event that the user lost their phone and needed to track it, they would tend to login with their email address and password, and a map would tend to display the exact location of their phone.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a perspective view of the mobile phone case with GPS tracking system of the present invention;

FIG. 2 is a side view of the mobile phone device with a case of the present invention; and

FIG. 3 is a perspective view of the mobile phone case of the present invention.

### DETAILED DESCRIPTION OF THE DRAWINGS

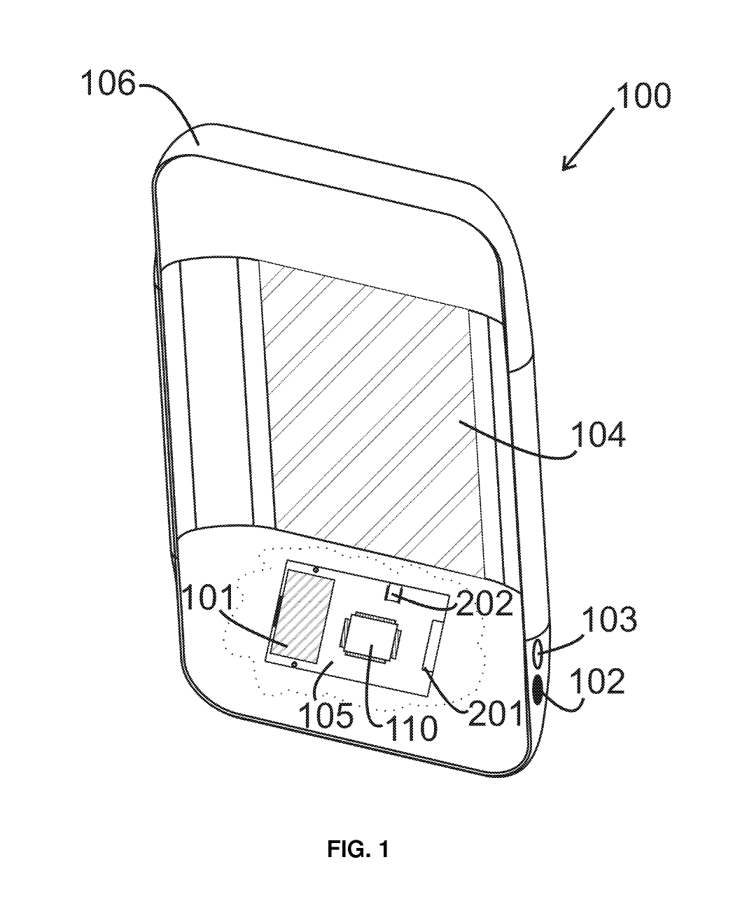

According to FIG. 1, the first embodiment of the present invention is the mobile device case 100 having a GPS device 101 embedded into the case 100. The GPS device 101 comprising of an electric circuit 105 with a processor 110 to process the functionality of the GPS device 101. The case 100 further has a power input 102 for charging a case battery 104 and an indicator 103 to indicate whenever the case battery 104 is low. The case 100 having means to receive the mobile device.

The mobile device case 100 of the present invention itself can tend to be similar to a standard smart-phone case. The primary difference can tend to be the GPS device 101 embedded into the case 100. In some embodiments, the GPS unit can be a micro GPS unit 101 that contains a small rechargeable battery 104, possibly recharging through solar or other renewable sources or through micro USB or another small interface as shown as the power input 102.

The mobile device case 100 may be formed in ways that is adapted to contain electronics 105 and preferably water resistant and formed from a shock resistant material to provide a secure functionality to the device. Said case 100 further may comprise sleeves 106 or recess formed within to receive a phone.

In the first embodiment of the present invention, the case 100 has all the necessary electronics like, electric circuit 105, GPS module 101 and battery 104 and a processor 110 to process and handle the GPS function for an electronic device to be able to communicate with satellites to send and receive signals and notify the user the location of the phone.

In the present invention, a functional logic programming switches from a phone battery to a case battery 104 when the phone battery is dead. The first thermometer 201, and second thermometer 202 which are embedded into the case 100 to measure the temperature of the phone battery and the ambient temperate. This can tend to be used to determine when the mobile device's battery is dead.

This would enable the GPS 101 to lie in a sleep state, and only transmit when the battery dies or the phone is turned off. The first thermometer 201 could tend to be placed directly over the phone battery to measure the temperature of the phone battery, while the second thermometer 202 could tend to measure the outside ambient temperature. Persons skilled in the art would appreciate that other thermometer configurations are possible. In such embodiments, the GPS device 101 embedded in the case 100 could tend to sit idle, only using minimum battery power, until the battery is completely cool and the unit is deemed to be without power. At that point the unit could tend to power up into full mode ready to be accessed.

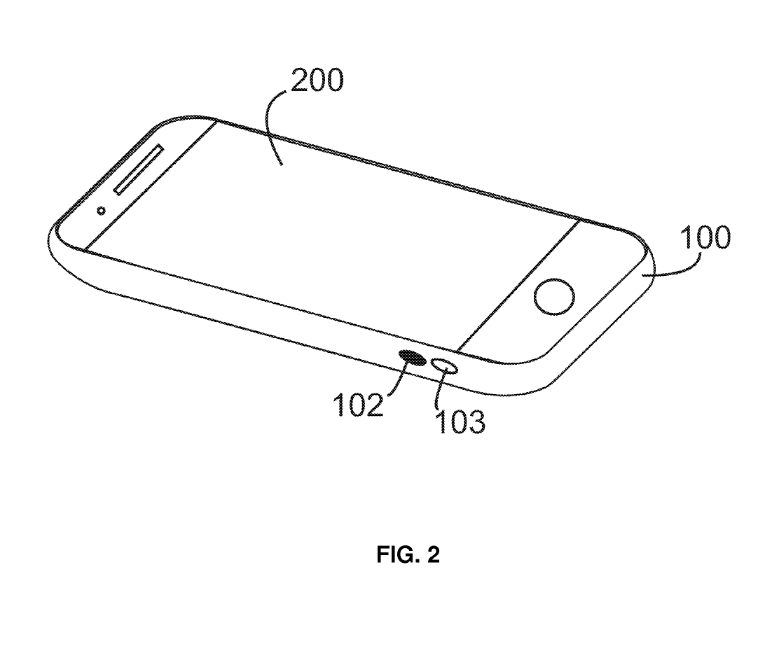

As shown in FIG. 2, power input 102 represents a power adapter for the internal battery in the GPS device embedded in the case 100. This enables a user to recharge the case battery, powering the small GPS device 101 embedded in the case 100. A small indicator light 103 can tend to blink when the case battery is low. Indicator 103 is an output device that informs the user when the case battery 104 for the GPS 101 device in the case 100 of a mobile device 200 is low.

In some embodiments, the GPS device may require an occasional charge. Person skilled in the arts will appreciate that other output devices could be used to display the battery life. Also, person skilled in the art will appreciate that various charging means including motion capture and solar technologies could be used for self-charging the battery in the GPS device embedded in the case. Other power sources and charging methods could be used by person skilled in the arts.

According to the first embodiment of the present invention, a mobile case that is easily attached to mobile phone and extends the functionality by a combination with GPS and thermometers may function as a standalone device. This is a solution to have an additional device for tracking the lost phone with extended battery life.

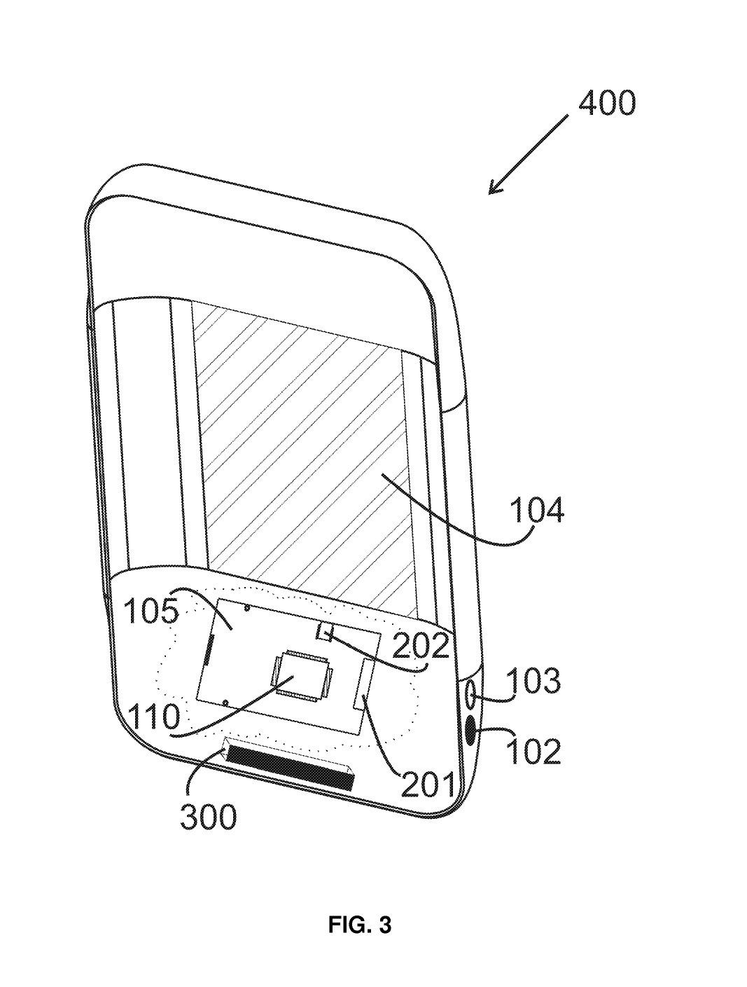

In another embodiment of the present invention as shown in FIG. 3, the case 400 has an extra battery 104 embedded inside the case 400 with two thermometers 201-202 to monitor and switch between a phone battery and a case battery 104 and a dock 300 to connect the phone to the case battery 104 in the case 400. In case of unfortunate incident does occur and the mobile phone lost, when the phone battery is dead, the case 400 by help of two thermometers 201-202 and the dock 300 connect the mobile device to the case battery 104 which is embedded inside the case 400.

As shown in FIG. 3, the case 400 uses a GPS device of a mobile and the case 400 has an ability to connect the case battery 104 to the mobile device in case when the mobile battery is dead. The case battery will charge the mobile device to turn ON the mobile device and use the GPS device embedded inside the mobile device.

In another embodiment of the present invention, the case could tend to have a unique PIN association. When the user first purchases the product, they could tend to register their PIN, on a website for example, where they could also setup a password and initialize their profile. In the event that the user lost their phone and needed to track it, they would tend to login with their email address and password, and a map would tend to display the exact location of their phone.

The forgoing is considered as illustrative only of the principles of the invention. Further, since numerous modification and changes will readily occur to those skilled in the art, it is not desired to limit the invention to the exact construction an operation shown and described, and accordingly, all suitable modifications and equivalents may be resorted to, filling within the scope of the invention.

With respect to the above description, it is to be realized that the optimum relationship for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by present invention.

What is claimed is:

1. A mobile device case for a mobile device having a first battery to operate, said mobile device case comprising of:
a. a housing to receive said mobile device;
b. a second battery being embedded in said housing;
c. a pair of thermometers embedded in said housing monitoring the temperature of said first battery and ambient surrounding said housing;
d. a GPS device to determine the location of the mobile device case;
e. an electronic communication means to communicate with a plurality of satellites to send and receive a data related to the location of the mobile device case; and
f. a processor to process the functionality of said second battery, said thermometers, said GPS device and said communication means and switch between said second battery and said first battery;
whereby the processor switches the power source of the mobile device from said first battery to said second battery when said first battery is dead.

2. The mobile device case of claim 1, wherein said mobile device case being water resistant and shock resistant.

3. The mobile device case of claim 1, wherein said thermometer to monitor said first battery temperature being placed on a place approximately near said first battery.

4. The mobile device case of claim 1, wherein said mobile device case having a means to charge said second battery of said mobile device case by solar technology.

5. The mobile device case of claim 1, wherein each said mobile device case assign a unique PIN which is registered in a website to continuously track said mobile device case.

6. A mobile device case for a mobile device having a first battery to operate, said mobile device case comprising of:
a. a housing to receive said mobile device;
b. a second battery being embedded in said housing;
c. a pair of thermometers embedded in said housing to monitor the temperature of said first battery and ambient surrounding said housing;
d. a dock being designed in said housing to connect the mobile device to the second battery; and
e. a processor to process the functionality of said second battery, said thermometers and switch between said second battery and said first battery;
whereby the processor switches the power source of the mobile device from said first battery to said second battery when said first battery is dead.

7. The mobile device case of claim 6, wherein said mobile device case being water resistant and shock resistant.

8. The mobile device case of claim 6, wherein said thermometer to monitor said first battery temperature being placed on a place approximately near said first battery.

9. The mobile device case of claim 6, wherein said mobile device case having a means to charge said second battery of said mobile device case by solar technology.

10. The mobile device case of claim 6, wherein each said mobile device case assign a unique PIN which is registered in a website to continuously track said mobile device case.
